(19) United States
(12) Patent Application Publication
(10) Pub. No.: US 2011/0119077 A1
(43) Pub. Date: May 19, 2011

(54) VIRTUAL MEDICAL SELF MANAGEMENT TOOL

(76) Inventors: Jon GICE, Avon, CT (US); Adam SEIDNER, Hartford, CT (US); Karen MEALEY, (US); David FORREST, (US)

(21) Appl. No.: 12/883,083

(22) Filed: Sep. 15, 2010

Related U.S. Application Data
(60) Provisional application No. 61/242,674, filed on Sep. 15, 2009.

(51) Int. Cl. G06Q 50/00; G06Q 10/00

(52) U.S. Cl. 705/2

(57) ABSTRACT

Systems and methods are disclosed herein for providing a virtual medical self management tool by an insurer to an injured person who sustained an insured bodily injury. In certain embodiments, these systems and methods provide medical self management information related to property/casualty insurance claims using a web portal. In a preferred embodiment, the systems and methods provide the medical self management information to injured employees covered through their employer by workers compensation insurance.

### CROSS-REFERENCE TO RELATED APPLICATIONS

This application claims the benefit of U.S. Provisional Application No. 61/242,674, filed Sep. 15, 2009, entitled “Virtual Medical Self Management Tool” and incorporated herein by this reference.

### BACKGROUND

Employees injured on the job are covered, through their employer, by workers compensation insurance. Current workers compensation processes are inadequately interacting with injured employees. It is in the interest of employers as well as employees to expedite the employees' recovery and return to work. Accordingly, it is desirable to devise systems and processes that achieve the above objectives.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1 is a system diagram of at least one embodiment of the invention and shows the overall architecture for providing an Explanation of Reimbursement (EOR) and an Explanation of Benefits (EOB) for workers compensation claims.

FIG. 2A is a flow diagram of at least one embodiment showing a batch job flow for generating an EOR.

FIG. 2B is another flow diagram of at least one embodiment showing a process for system generated correspondence relating to an EOB and an EOR.

FIG. 3A is an example of the cover letter sent to an injured employee when a claim is accepted and the injured employee is not represented by an attorney.

FIG. 3B is an example of a letter sent to an injured employee when a claim is accepted and the injured employee is represented by an attorney.

FIG. 3C is an example of a letter sent to an injured employee when a claim is denied and the injured employee is not represented by an attorney.

FIG. 3D is an example of a letter sent to an injured employee when a claim is denied and the injured employee is represented by an attorney.

FIG. 4A is an example EOR sent to a health care provider showing information on medical (or health care) services received by an injured employee and the payments made to the health care provider by the insurer for the services.

FIG. 4B is an example EOB sent to an injured employee showing information on medical services received by the injured employee and the payments made to the health care provider by the insurer for the services.

FIG. 4C is an example an explanation page (or glossary) that is provided with the EOB and cover letter which together form an EOB package.

FIG. 5 is a screenshot showing the process of creating a referral for investigation of fraud claims associated with providing payments to health care providers.

FIG. 6 is a screenshot showing the tracking and investigation of fraud claims associated with providing payments to health care providers.

FIG. 7 is a screenshot showing a medical bill lookup search screen for searching for health care provider bills and the associated EORs.

FIG. 8 is a screenshot showing the results of a search.

FIG. 9A is a screenshot from a public web portal designed specifically for injured employees.

FIG. 9B is a flow diagram of at least one embodiment showing the overall process for providing information and self help tools to an injured employee using a web portal.

FIG. 10 is an example of the injured employee's claim status and financial information that can be included within a web portal.

FIG. 11 is an example of a medical self-help component of a web portal.

FIG. 12 is an example of a component of a web portal where a user can learn more about their specific injury.

FIG. 13 is an example of a component of a web portal where a user can educate themselves about exercise and behavioral methods.

FIG. 14 is an example of a component of a web portal where a user can electronically communicate with their claim case manager, medical case manager and/or supervisor.

FIG. 15A is an example of a component of a web portal where a user can track their recovery progress.

FIG. 15B is an example of a component of a web portal where a user can create one or more recovery-related tasks.

FIG. 16 is an example of a component of a web portal where a user can learn more about making behavior changes.

FIG. 17 is an example of a component of a web portal where a user can learn more about making lifestyle changes.

FIG. 18 is an example of a component of a web portal where a user can verify services provided or not provided.

FIG. 19A is a flow diagram of at least one embodiment showing the process of verifying services provided.

FIG. 19B is a flow diagram of at least one embodiment showing the process of investigating health care fraud.

### DETAILED DESCRIPTION OF THE PREFERRED EMBODIMENTS

Systems and methods are disclosed herein for providing a virtual medical self management tool by an insurer to an injured person who sustained an insured bodily injury. As used herein, injury is defined to include disease.

In certain embodiments, the present invention provides systems and methods for providing an injured employee with medical self help tools and resources, return to work management information, and financial details by an insurer.

In a preferred embodiment, the invention provides a web portal with tools and information to injured employees (the users) to help them understand the workers compensation process and to help them rehabilitate in a timely manner. The web portal can help employers manage workers compensation outcomes and bring injured employees back to work as soon as medically appropriate.

The web portal can, for example, provide access to claim status and claim payment information, provide a multi-media overview of the workers compensation process to clearly inform injured employees of their rights and, provide online support to answer injured employees' questions, and/or provide access to most common state forms needed to expedite workers compensation claims. The web portal can be available in English or another language.

Certain embodiments of the present disclosure are directed to providing an Explanation of Benefits (EOB) and/or other medical and financial information to an injured employee. The injured employee is covered for job related injuries through his/her employer's workers compensation insurance policy which the employer obtains from an insurance carrier. Accordingly, the employee has no obligation to pay for medical expenses relating to injuries covered by the employer's workers compensation policy (i.e., compensable claims). The present disclosure provides a new connection, relationship, and array of services among the insurer, the health care provider, and the injured employee.

While the disclosure herein has been described as being used with regard to an injured employee for a workers compensation injury claim, it should be understood that the disclosure herein may be used with other first party or third party claimants for other types of property and/or casualty injury related claims. For example, for a first party automobile claimant, when an insured driver, or family member thereof (collectively, “injured person”), is injured in an automobile accident that is covered by his/her automobile insurance and receives medical services, the injured person may also receive an EOB from the insurance company and/or have access to the other services described herein for the injured person. The disclosure also applies to any other first party injury related property/casualty claimant. Further, this disclosure applies to any third party injury related property/casualty claimant, such as a third party liability claimant (e.g., injured person covered by another's business or property liability insurance), a third party automobile claimant (e.g., injured person covered by another person's automobile insurance), or any other third party injury related property/casualty claimant. In that case, the injured person would be the third party claimant and would receive the EOB and/or have access to the other services described herein for the injured person.

An Explanation of Reimbursement (EOR) is a document (or statement) sent to a health care provider describing the medical services provided to an individual, the costs of the services, and the reimbursements paid (or payments made) to the health care provider by the insurer. The EOR traditionally goes to the medical provider to inform them of the services that have been paid for by the insurer on behalf of the policyholder. More specifically, it can document health care provider bill reductions as a result of re-pricing the bills based on state mandated fee schedules, usual and customary schedules, or preferred provider organization (PPO) reductions.

In some states (such as Michigan), the EOR sent to the health care provider is called an Explanation of Benefits, which can be confused with the EOB described below sent to the injured employee. For the purposes of this disclosure, the documents sent to the health care provider will be called an EOR.

An Explanation of Benefits (EOB) is a package of information or documents sent to the injured employee/person that may include an EOB statement, a cover letter, and a glossary (collectively, the EOB package). As used herein the phrase “BOB package” and EOB may be used interchangeably. The EOB package provides similar information as the EOR, but also provides additional information to help the recipient better understand the health benefits rendered in an easy to understand description, identifies the name of the insurance company representative and invites communication with that person, provides an encouraging message regarding recovery, allows for verification of health care services provided, and invites access to a web portal where additional virtual medical/health self management tools exist. An EOB is typically used in group health insurance but is not commonplace in workers compensation.

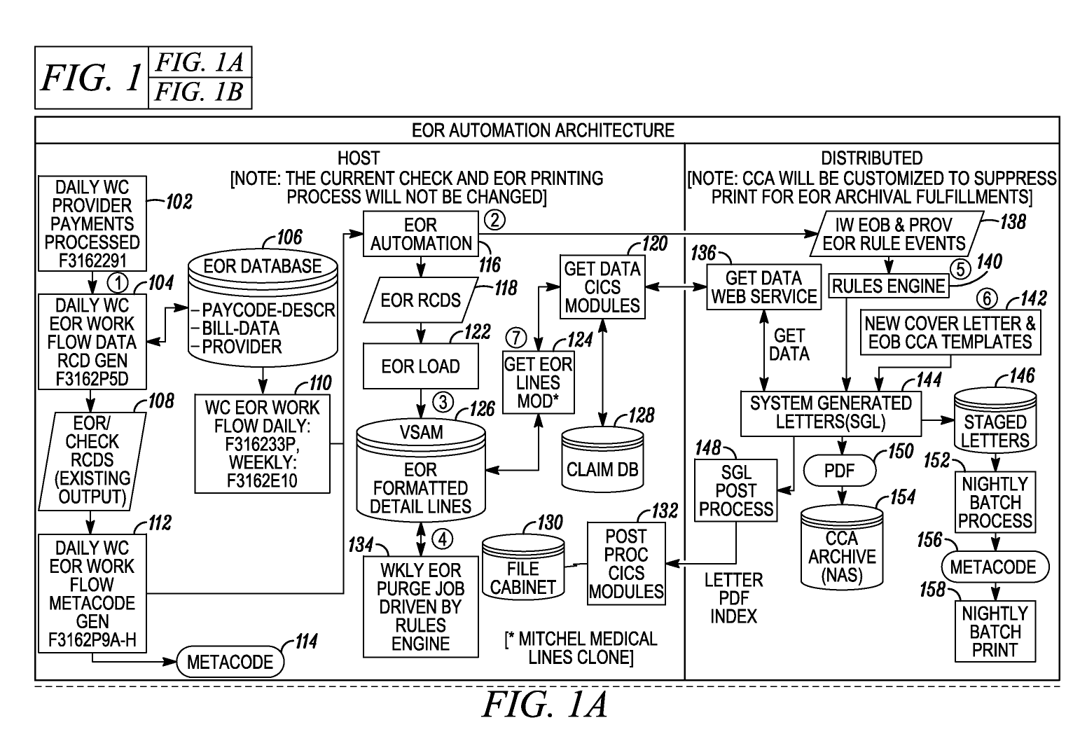

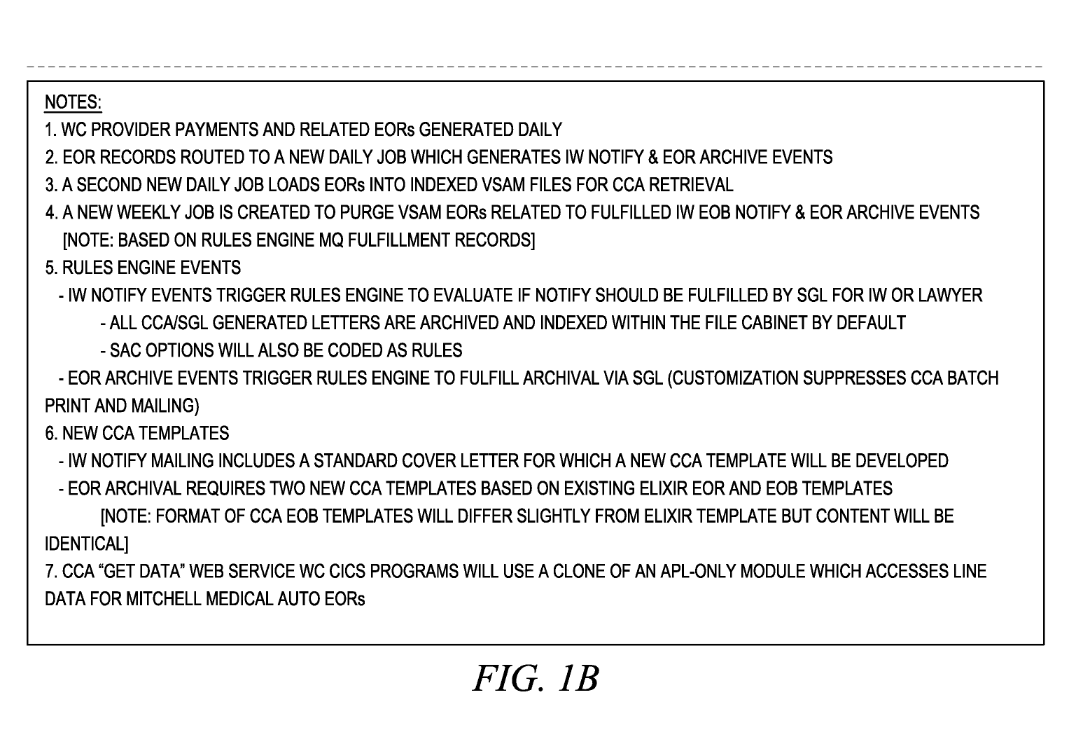

FIG. 1 is a system diagram of at least one embodiment of the invention, and shows the overall architecture for providing an EOR and EOB with cover letter/glossary for workers compensation claims. The architecture includes interconnected payment systems for paying health care providers, data storage systems for storing claim data, EORs and EOBs, EOR and EOB generating systems, a rules engine for determining the actions to take, and a printing/delivery system.

At 102, payments to health care providers are processed, and the process of sending an EOR to health care providers and the EOB package to injured employees begins. At 104, the data is received, and information is collected from database 106. The information collected includes the pay code description, the bill-data, and the provider data. This information is later used to generate the EOR and EOB package that go along with each payment that was processed.

At 108, the EOR is generated, and at 112, metacode is generated for the EOR to be printed. These are then sent to the health care providers along with the processed payments. Metacode 114 is used with high speed printers to print large volumes of EORs for sending to health care providers.

At 116, the process of sending the EOB package to injured employees begins. Events are generated that instruct the system to perform certain actions. At 118, the EOR records to be generated are received. At 122, the data to complete the cover letter and the EOR is loaded from Virtual Storage Access Method (VSAM) 126. This can include loading all the detailed data regarding treatments and dates. At 134, the data for the EOR is purged periodically, or when necessary. At 124, the detailed data for entries on the EOR are loaded, by component 120 from database 128, which contains claim data. At 136, a client server receives the EOR data, for example, either in a paper format or, preferably, over the internet. At 144, the data is used to generate letters to send to the injured employee. The cover letter and EOB can be formatted using templates provided at 142. Also, at 144, an electronic copy of the EOR (“EOR copy”) is created for later use.

At 138, the events and data received from automation component 116 are used with rules engine 140 to determine which actions need to be taken. This can include determining which injured employees will receive an EOB, and when they will receive them. For example, an EOB sent to an injured employee who is represented by an attorney, must also be sent to the attorney. As another example, the platform rules may determine that this injured employee should only be sent an EOB once a month, or that it should contain certain summarized information.

After the cover letter and EOB, and EOR copy, are generated at 144, three other processes are performed: storage to docketing systems 148, 132, 130, storage for archiving 150 154, and printing 146, 152, 156, 158. Storage to docketing systems is done to make the EOB accessible to customer service representatives and staged for access to claim or EOB data by injured employees, for example, through an online web portal. These processes include post processing of the EOB at 148. The EOB is then further processed at 132 so that it can be stored in the claim electronic file cabinet 130 in an organized manner for access by customer service representatives or adapted for access by injured employees.

At 150 a PDF version of the EOB is stored in an archive 154 for future retrieval. For example, this PDF version may be retrieved when an injured employee has a question about the mailing. At 146, the EOB is staged for a batch printing process. At 152, the staged EOB is retrieved and metacode 156 is generated for the batch printing/delivery 158.

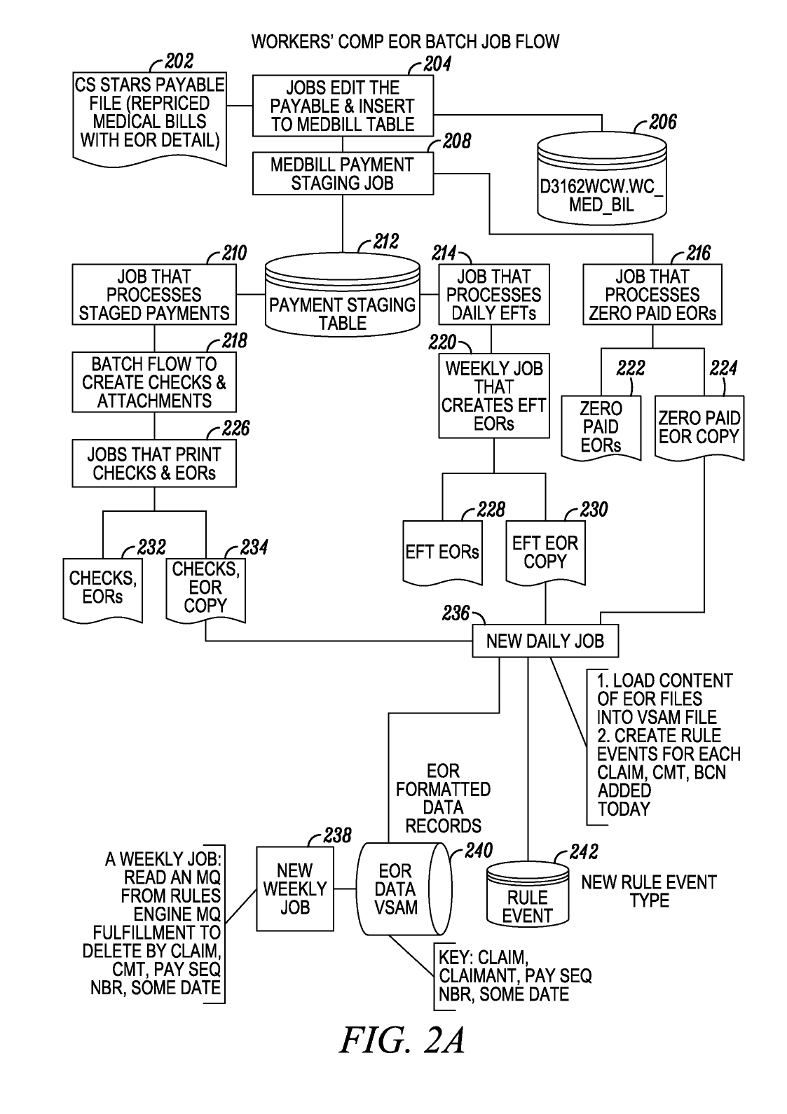

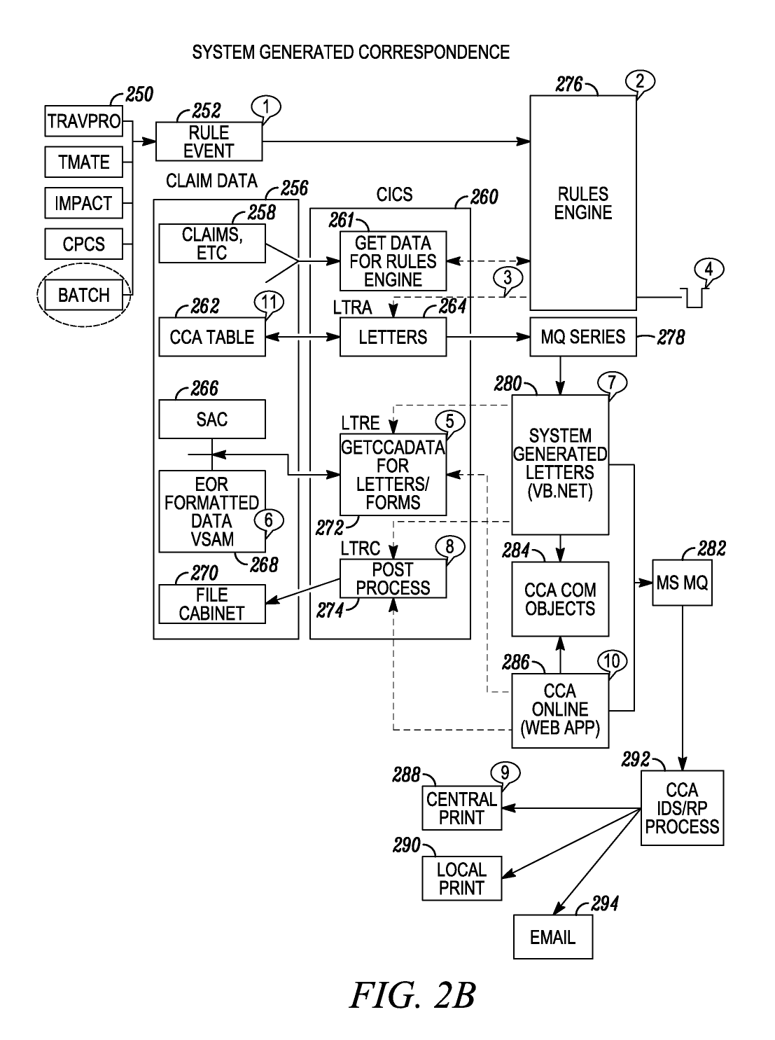

FIG. 2A is a flow diagram of at least one embodiment of the invention, and shows a batch job flow for generating an EOR. At 202, re-priced medical bills with EOR data are received (known as medical bill re-pricing). At 204, the payable amount is edited and the data is inserted into the medical bill table using data in database 206. At 208, staging of the re-priced medical bills is done and they are placed into staging table 212.

At this point, the billing data is processed to generate the EOR in one of three ways, for EORs with checks, with Electronic Funds Transfers (EFTs), or with no payments. At 210, the process for EORs with checks is started. At 210, a job is run that processes the staged payments. At 218, the checks are created corresponding to the payments, and at 226 the checks and EORs are printed. At 232, checks are sent out to the health care provider along with the EOR. For example, these can be in the same envelope. At 234, a copy of the EOR is generated and sent to 236 to be modified for sending sent to the injured employee as an EOB.

At 236, the content of EOR VSAM 240 is used to set the foundation for creating the EOB for the injured employee. This is done in accordance with rules stored within rule event data repository 242. At 238 data is purged periodically from EOR VSAM. As described above the rule events determine the actions that are taken.

At 214, the staged data is processed to generate daily EFTs. At 220, the data is processed to generate weekly EFTs. At 228, the EFT EORs are sent to the health care provider, and a copy 230 is used to create and send an EOB to the injured employee starting at 236, as described above.

At 216, the zero paid EORs, i.e., those where there was no payment to the health care provider, are processed. At 222, the zero paid EORs are sent, and at 224 the rules engine dictates that the EOB is not sent to the injured employee on a zero paid EOR unless required by state regulators.

FIG. 2B is another flow diagram of at least one embodiment of the invention that shows the overall process for providing an EOR for workers compensation claims. Business lines 250 generate events that can result in correspondence. This includes the claim systems for all lines of business including TMATE, Impact, CPCS, and batch jobs, including that described in FIG. 2A. At 252, rules events are generated based on the EOR batch jobs (FIG. 2A). At 276, rule events are applied to determine whether an EOB should be sent, and what the format should be.

At component 256, claims data is collected and used to generate the EOB. The claims data includes the claim data itself 258, the CCA table 262, the SAC 266, and the formatted EOR data 268. The file cabinet 270 is used to store an organized copy of the EOB and EOR after they have been sent.

CICS component 260 of the claim system has a component 261 that gets the claims data 258 so that it can be processed by the rules engine 276. The CICS 260 also has a component 264 responsible for generating letters/correspondence. Creation of the EOB and EOR copy are combined with the System Generated Letters process 280 through messaging queue 278. For the creation of the EOB and EOR copy, component 272 retrieves EOR data from 268 and processes it so that the EOBs and EORs can be generated by component 280.

Component 280 is connected to CCA COM objects 284, as well as Claim Correspondence Application (CCA) 286, which may be staged for access to claim or EOB data by injured employees/people through an on line web portal. Component 280 is also connected to printing and delivery systems 288, 290, and 294 (e.g., email, Short Message Service (SMS) text) through Messaging Queue (MQ) component 282 and processing system 292.

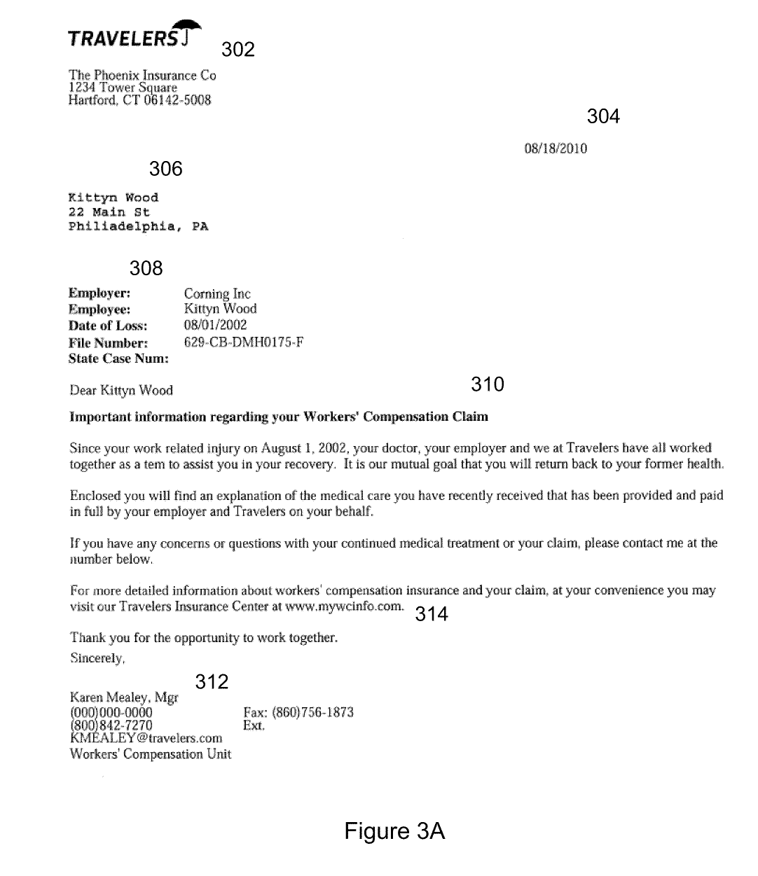

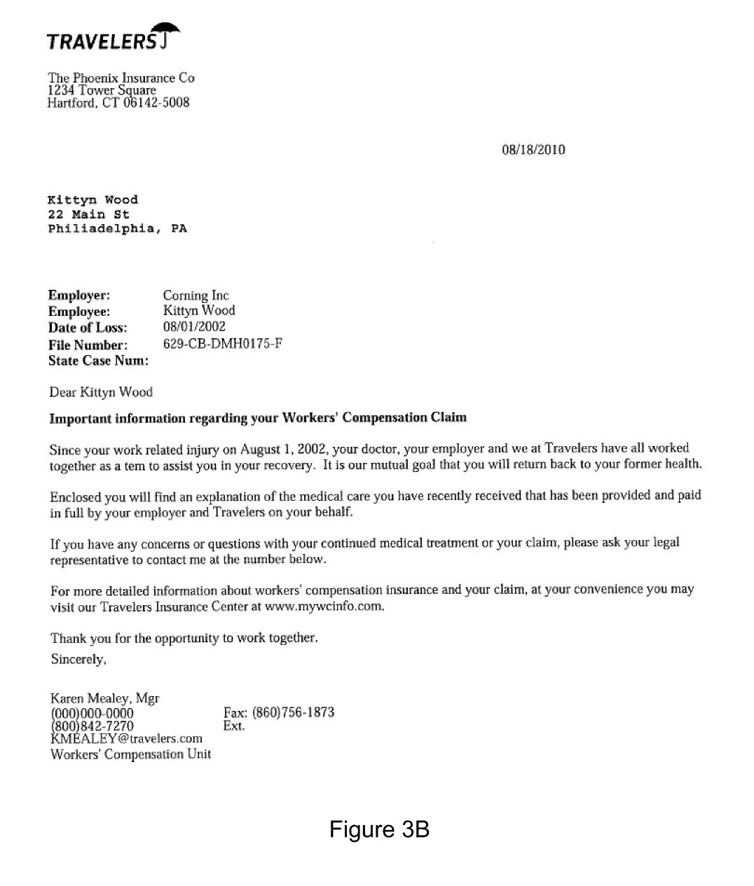

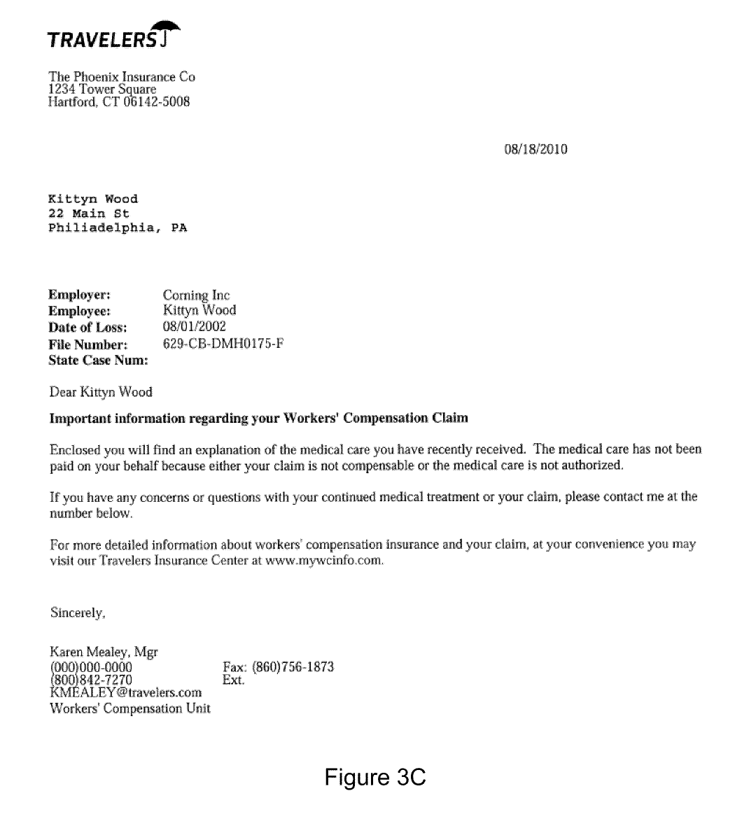

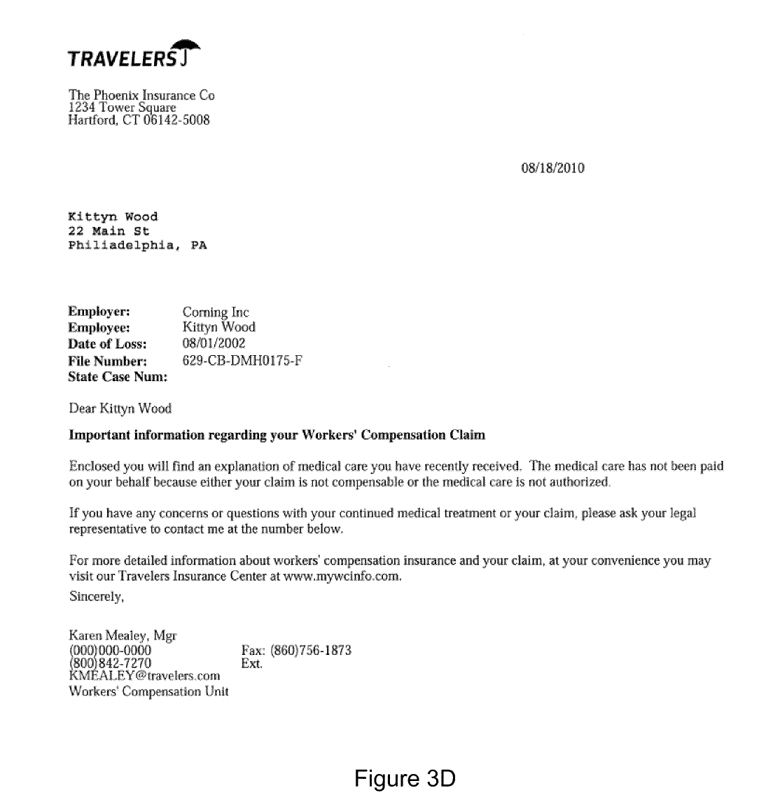

FIG. 3A is an example cover letter sent to an injured employee along with an EOR. The letter includes information on the insurer 302, the identity of the injured employee 306, the date of the communication 304, information about the employer 308, the notice 310, and contact information at the insurer or employer 312. Information on the insurer 302 includes the name of the insurer and their address. In other embodiments of the invention, this may be an email address, a website header, or fax header. The identity of the injured employee 306 identifies the worker, for example, their name and address.

The employer information 308 includes the name of the employer, the name of their injured employee, the date of loss (i.e., date of injury), and a file number (i.e., tracking number) that can be used to identify the matter. This tracking number can be used to identify the injury, the cover letter, the EOR/EOB, and any investigation related to the injury or reimbursement. In this way a single identifier can be used to identify the entire case. The notice 310 can be used to inform the injured employee about the EOB, because they are a third party and therefore may not have been expecting the EOB, or know what to do in response. The notice can also address common questions. The letter can also include contact information for a contact at the insurer or employer 312. The letter can also include a uniform resource locator (URL) for a web portal provided by the insurer 314. If the EOB is delivered electronically, this or another URL is an active link to the web portal.

FIG. 3B is an example of a letter sent to an injured employee along with an EOR, together creating the EOB, when a claim is accepted and the injured employee is represented by an attorney. FIG. 3C is an example of a letter sent to an injured employee when a claim is denied. FIG. 3D is an example of a letter sent to an injured employee when a claim is denied and the injured employee is represented by an attorney.

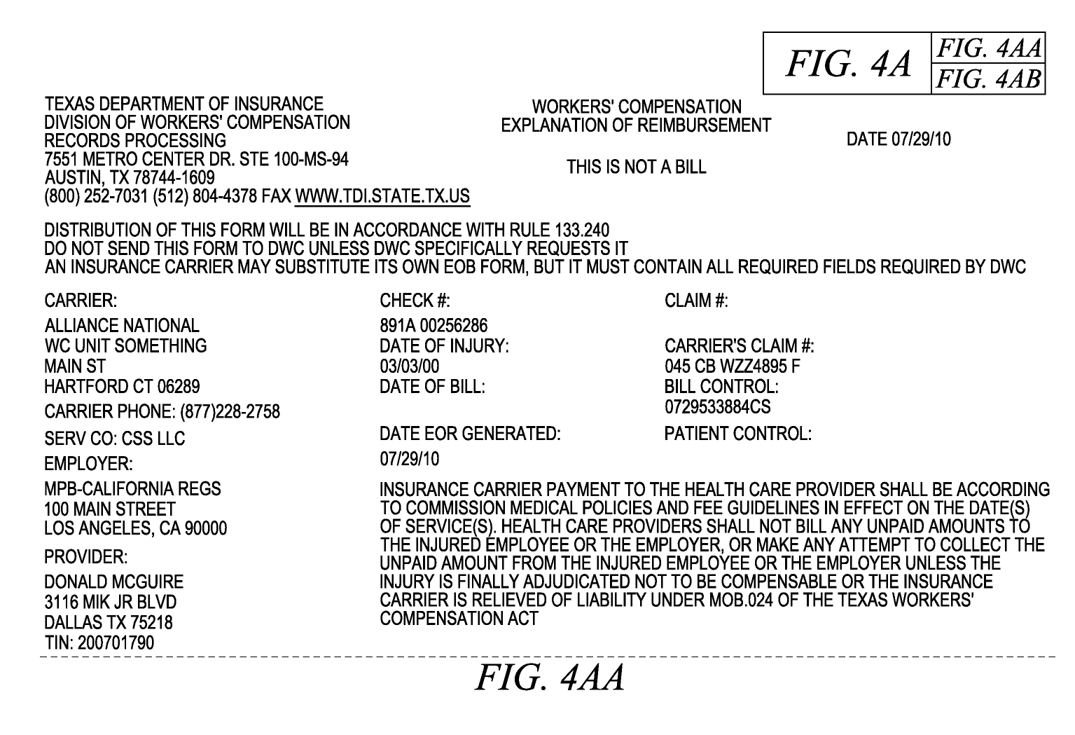

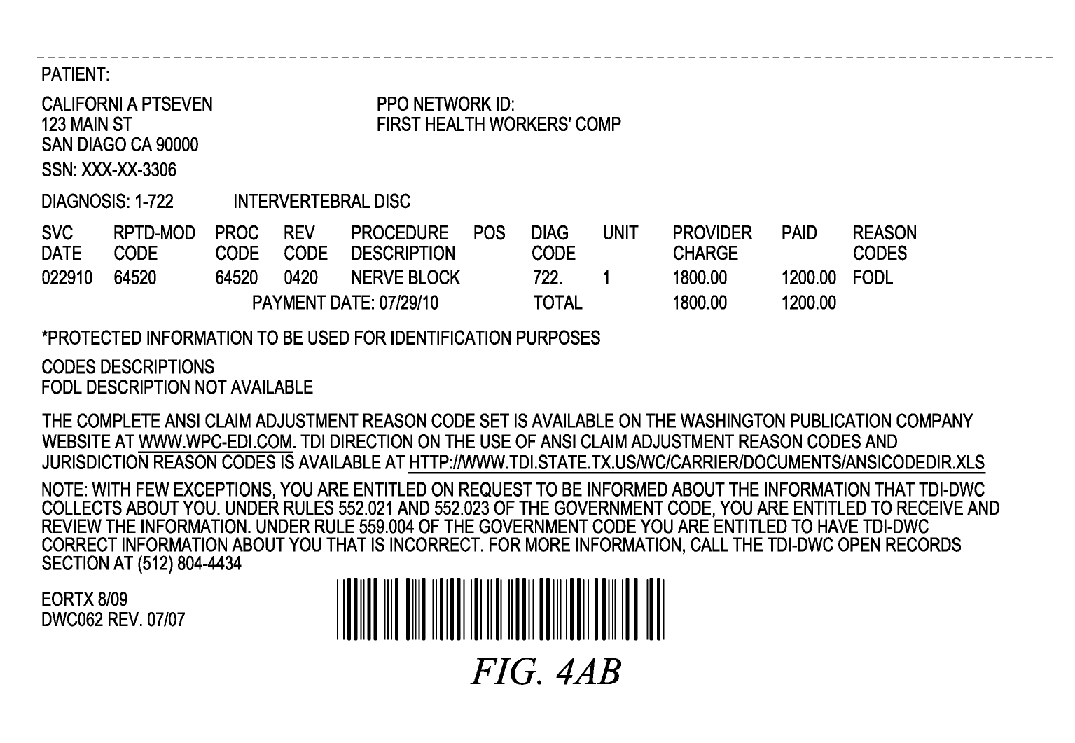

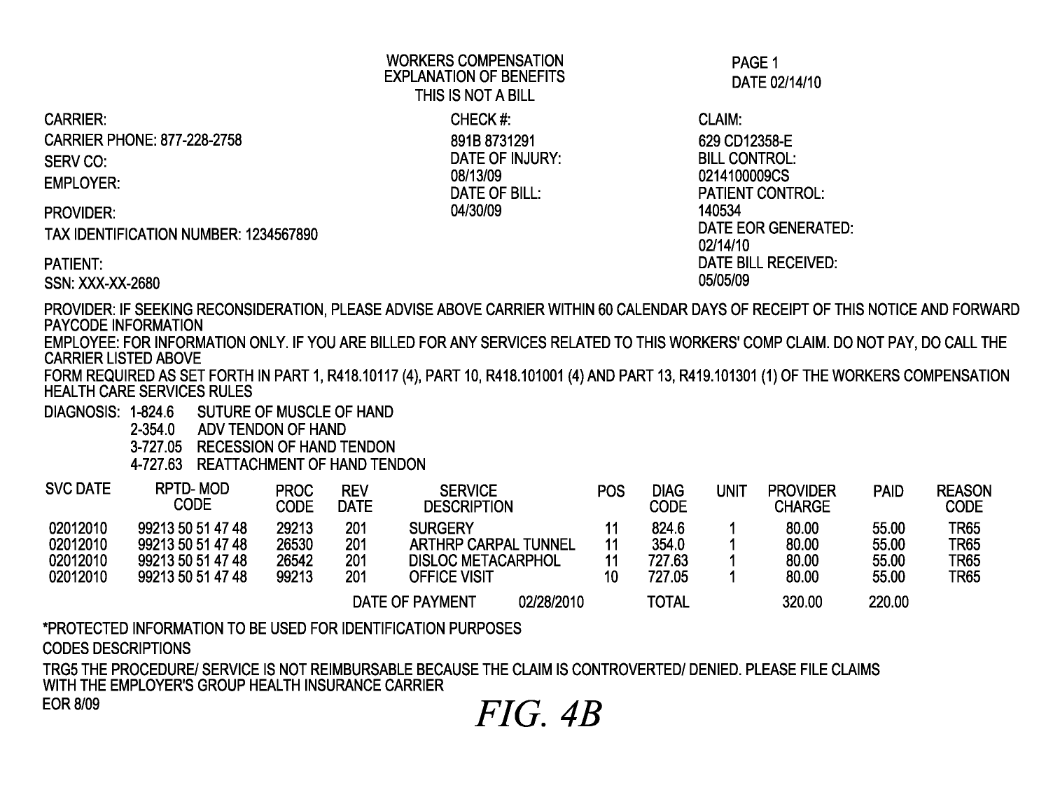

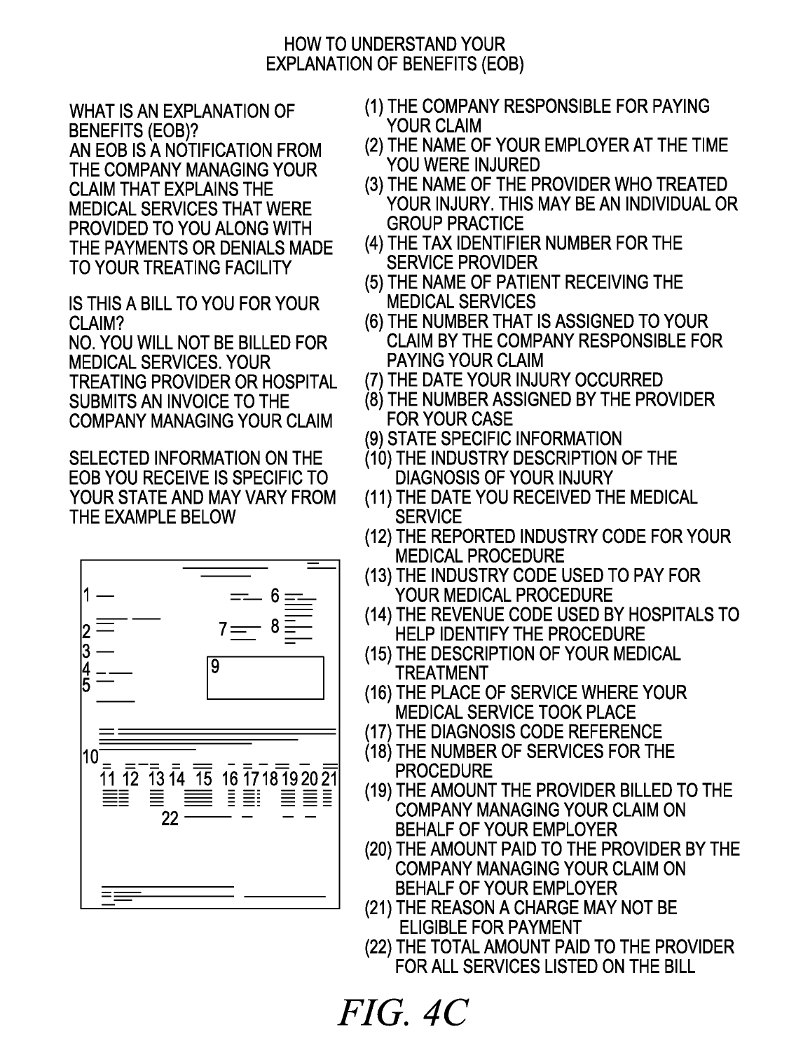

FIG. 4A is an example EOR showing information on health benefits (medical services) received by the individual and reimbursement provided by the insurer. In some embodiments of the invention, the EOR is sent along with a cover letter as shown FIG. 3, together creating the EOB.

The EOR can cover each medical payment separately (e.g., one visit to a health care provider), or it can include multiple medical payments (e.g., all payments in a month). The EOR can also provide various levels of summary data. For example, it can provide summary data for one visit (e.g., total cost), or for a certain time period (e.g., total cost for a month). In addition, an EOB covering more than one visit could combine these summaries together, and provide higher levels and lower levels summaries (e.g., each week, and the monthly total). Other information on the EOR, such as the reimbursement amounts can be handled similarly. Alternatively, the EOR can include just a subset of the information from the health care provider's bills. This can be useful if the bills are too long (e.g., only include one page of service entries), or it is desired to highlight certain information (e.g., the largest expenses or those procedure that are at highest risk for fraud). The EOR includes a clear notice that it is not a bill. The EOR and/or the cover letter can also include a notice regarding who the injured employee can contact about the EOB. By reviewing the services provided, an injured employee can determine if they in fact received each of those health care services. If there is any discrepancy, they can contact their insurer representative or employer using contact information provided on the EOR and/or the cover letter.

In some embodiments of the invention, the cover letter and EOR are sent along with additional page providing information to help the individual understand the EOB. The additional page provides descriptions of the different sections of the EOR, and may include a schematic graphic of the EOR for further clarity.

FIG. 4C is an example additional page. This page indicates which sections of the EOR present what information, for example, the page indicates the parts of the EOR that present: the company responsible for paying the claim 1, the name of the employer at the time the employee was injured 2, the name of the provider who treated the injury (may be an individual or group practice) 3, the tax identifier number for the service provider 4, the name of the patient (employee) receiving the medical services 5, the number assigned to the claim by the company responsible for paying the claim 6, the date the injury occurred 7, the number assigned by the provider for the case 8, state specific information 9, the industry description of the diagnosis of the injury 10, and, for each procedure performed: the date the medical service was received 11, the reported industry code for the medical procedure 12, the industry code used to pay for the medical procedure 13, the revenue code used by hospitals to help identify the procedure 14, the description of the medical treatment 15, the place of service where the medical service took place 16, the diagnosis code reference 17, the number of services for the procedure 18, the amount the provider billed to the company managing the claim on behalf of the employer 19, the amount paid to the provider by the company managing the claim on behalf of the employer 20, the reason a charge may not be eligible for payment 21, and the total amount paid to the provider for all services listed on the bill 22.

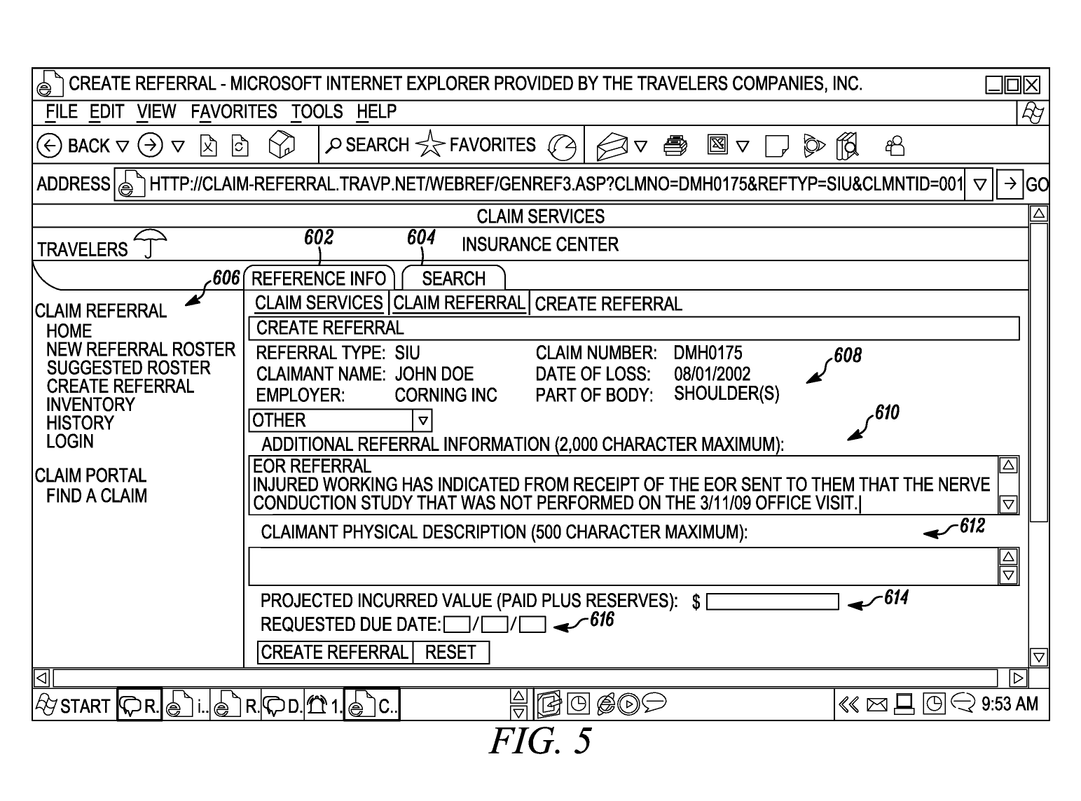

FIG. 5 is a screenshot showing the process of creating referrals for investigation of fraud claims associated with providing reimbursements. The referral application, which can be part of the case management application, includes reference information 602, and a search function 604 to search for cases or referrals. To create a referral, the user fills out case information 608. Alternatively, this can be completed automatically by case management system. The user also completes any additional information about the case 610, information on the claimant 612, the value of the claim 614, and the date completion of the investigation is desired 616.

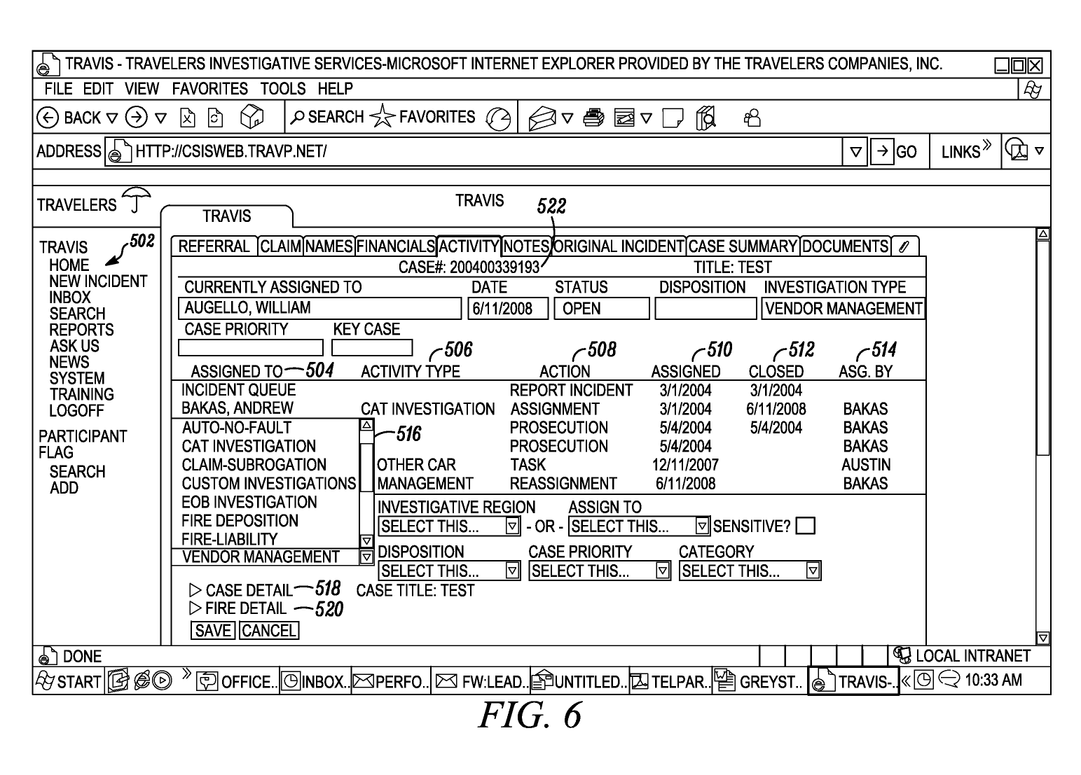

FIG. 6 is a screenshot showing the tracking and investigation of fraud claims associated with providing reimbursements. FIG. 6 shows a screenshot from a case management system capable of managing fraud investigations. The management system can manage cases by case number 522. It shows the investigator a case is assigned to 504, the type of activity being performed on the case 506, the type of action the case is in 508, when the case was assigned 510, when the case was closed 512 (if closed), and who assigned the case to the investigator 514. The system can also have a case type parameter 516, can present additional case detail 518, and fire detail 520. The case type parameter 516 allows the case management system to handle multiple types of cases (workers compensation fraud, auto injury fraud, fire, etc.). Additional case detail 518 can include each of the actions taken so far in the case. It can also include any facts or documentation that has been collected.

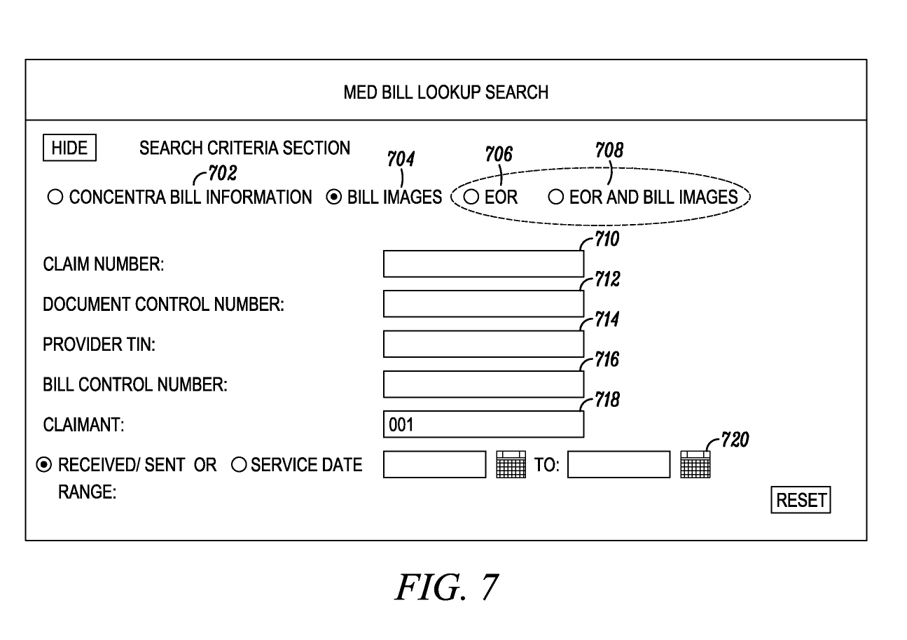

FIG. 7 is a screenshot showing searching for health care provider bills and the associated EORs. The system can be used to search for medical and/or pharmacy bills according to the one or more criteria of claim number 710, document control number 712, provider taxpayer identification number (TIN) 714, bill control number 716, and claimant 718. A date range 720 can also be used to limit the search results. The selection option at the top 702-708 can be used to select the desired results. These can be just the bill data 702, the images of the bills 704, just the EOR 706, and the EOR and the corresponding linked bill images 708.

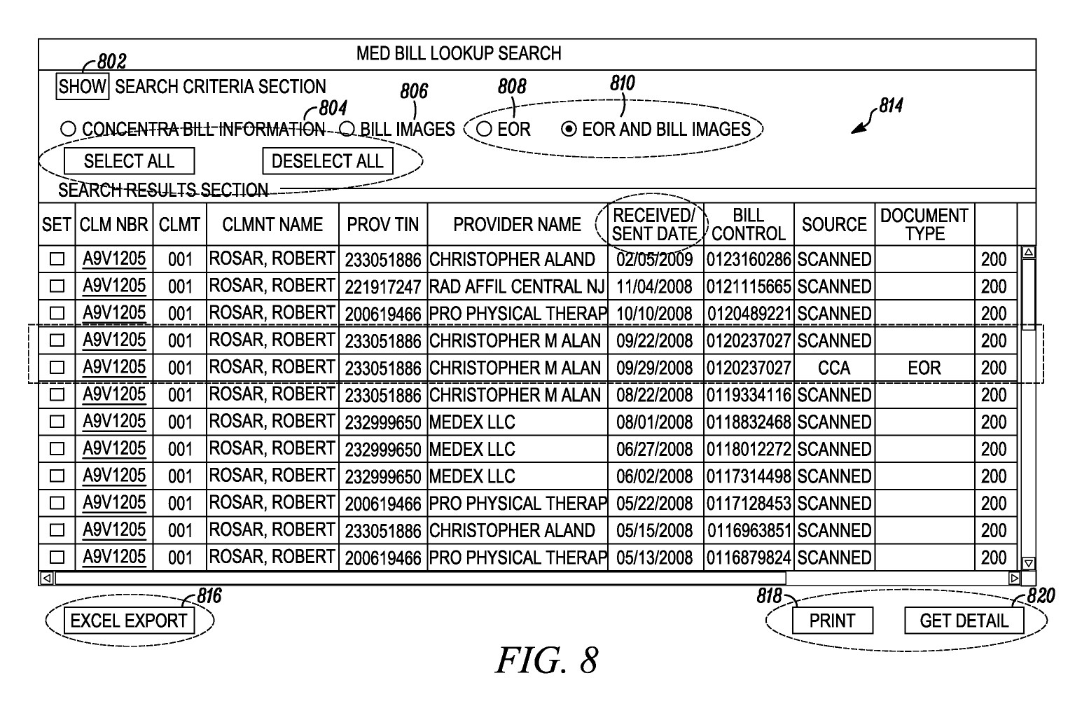

FIG. 8 is a screenshot showing the results of a search. The results include for each claim, the claim number, claimant, claimant name, provider TIN, provider name, data of claim, bill control number, source of the data, and the document type. These results can be exported to an Excel file using button 816, printed using button 818, or further reviewed using detail button 820. Buttons “select all” and deselect all” 812 can be used to select or unselect all the results. Additionally, a user can use the checkbox next to each entry to select it, and manage it in a group with other entries. Button 802 can be used to show the search criteria. Buttons 804-810 select the type of data shown in the result as described above with respect to FIG. 7.

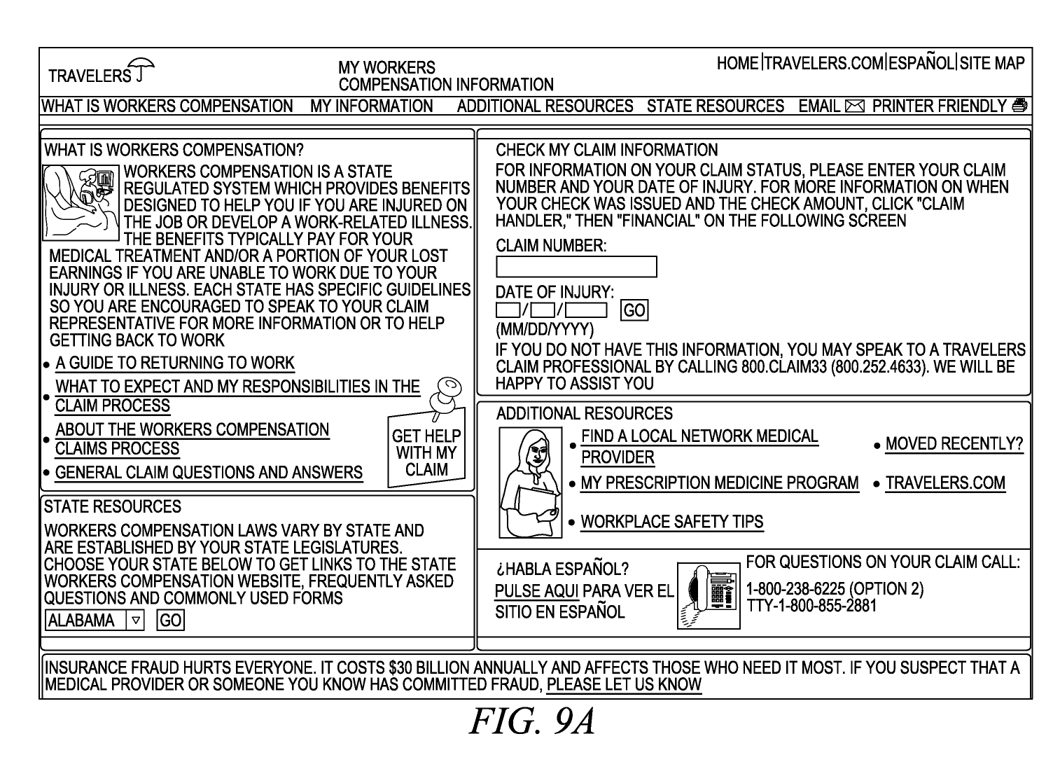

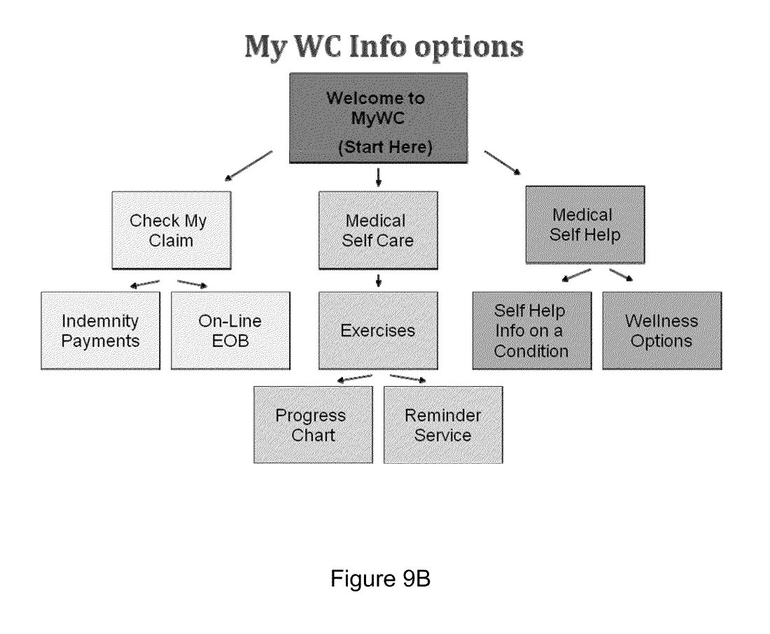

FIG. 9A is a screenshot from a web portal (e.g., mywcinfo.com). It shows that a user can use the web portal to check on the status of a claim, review payments to the injured employee, access state rules and regulations, receive answers to frequently asked questions, and locate a network medical provider, among other functions.

Features of the web portal can be customized for different employers/organizations so that the web portal is specific to a particular organization. In certain embodiments, the insurance management computer system can provide member specific information from an insurer to a plurality of members of a plurality of organizations insured by the insurer. The insurance management computer system can, for example, electronically receive a request from at least one of the plurality of members including member specific claim information, determine which organization the individual is a member of based on the member specific information, and provide the web portal with differential access and/or features based on the organization that the system determines the individual is a member of. In certain embodiments, the insurance management computer system provides access, responsive to the member specific claim information, to a first portal for the at least one of the plurality of members to view the member specific information, a second portal for the at least one of the plurality of members to access medical self-help programs, and/or a third portal for the at least one of the plurality of members to communicate directly with the insurer and/or a medical professional.

FIG. 9B is a flow diagram of at least one embodiment showing the overall process for providing information and self help tools to an injured employee using a web portal.

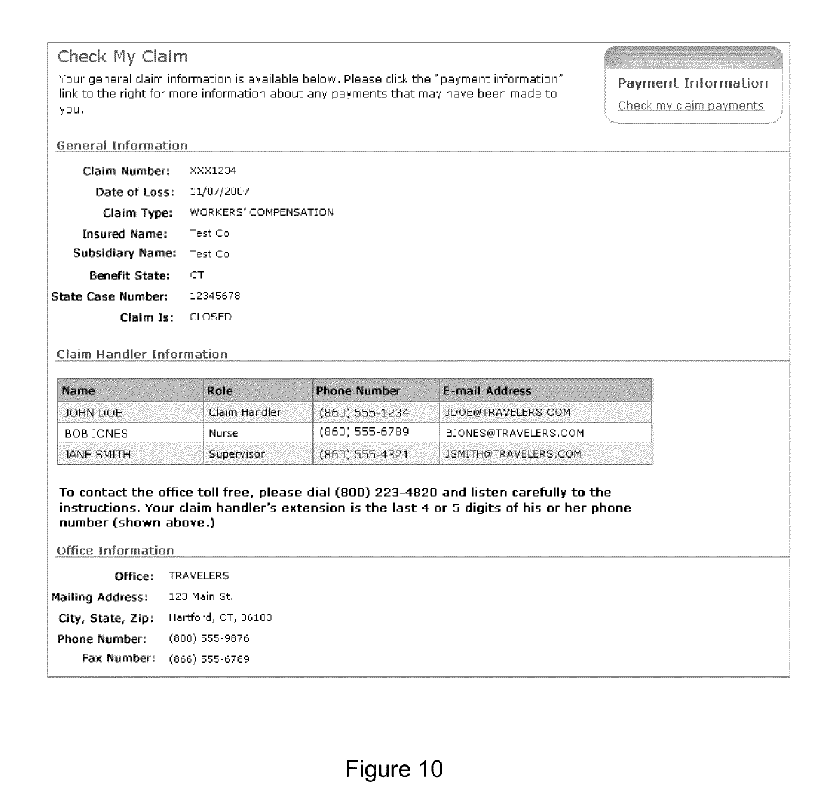

FIG. 10 is an example of an EOB that can be included within a web portal. The EOB can provide clear and simplified display of claim status and claim payment information, include additional financial summary information, and provide notification of disability payments and other payments made to the injured employee. This EOB can be personalized and updated in real time for showing an injured employee the latest information. For example, it can be updated with a visit the injured employee made to a health care provider that same day. This EOB can also include multiple options for the injured employee to view the data, including viewing summarized or detailed information, viewing certain dates, sorting by health care provider, and/or sorting by payment type.

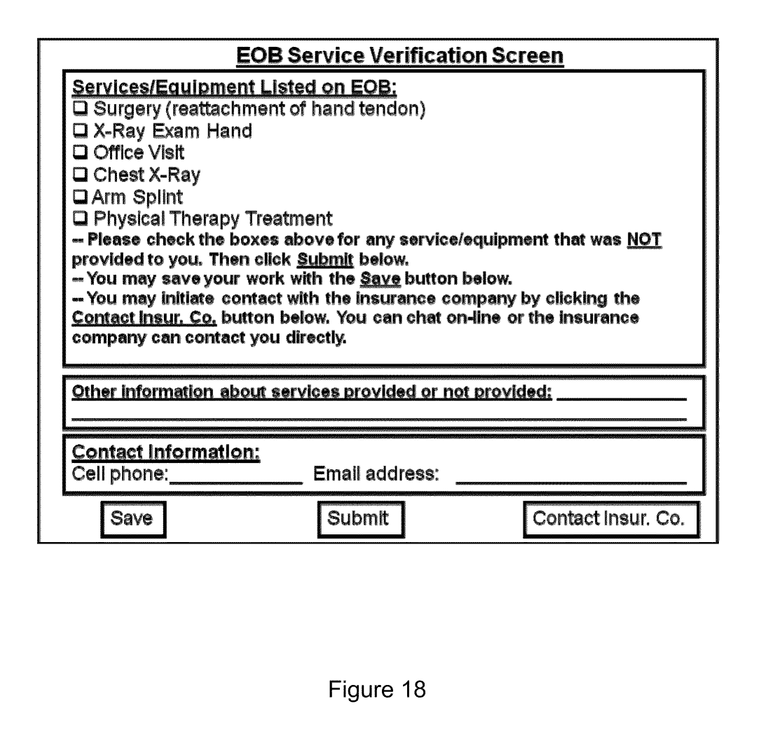

The web EOB can also be interactive, so that the injured employee can easily select or otherwise indicate those treatments that were not actually performed by the health care provider, or are different from what was actually performed (see FIG. 18 and associated description). The injured employee can be directed to the web portal through a communication containing a URL. The communications can include a letter, email, SMS text, fax, or phone call. The injured employee can then use the received URL to access the web portal.

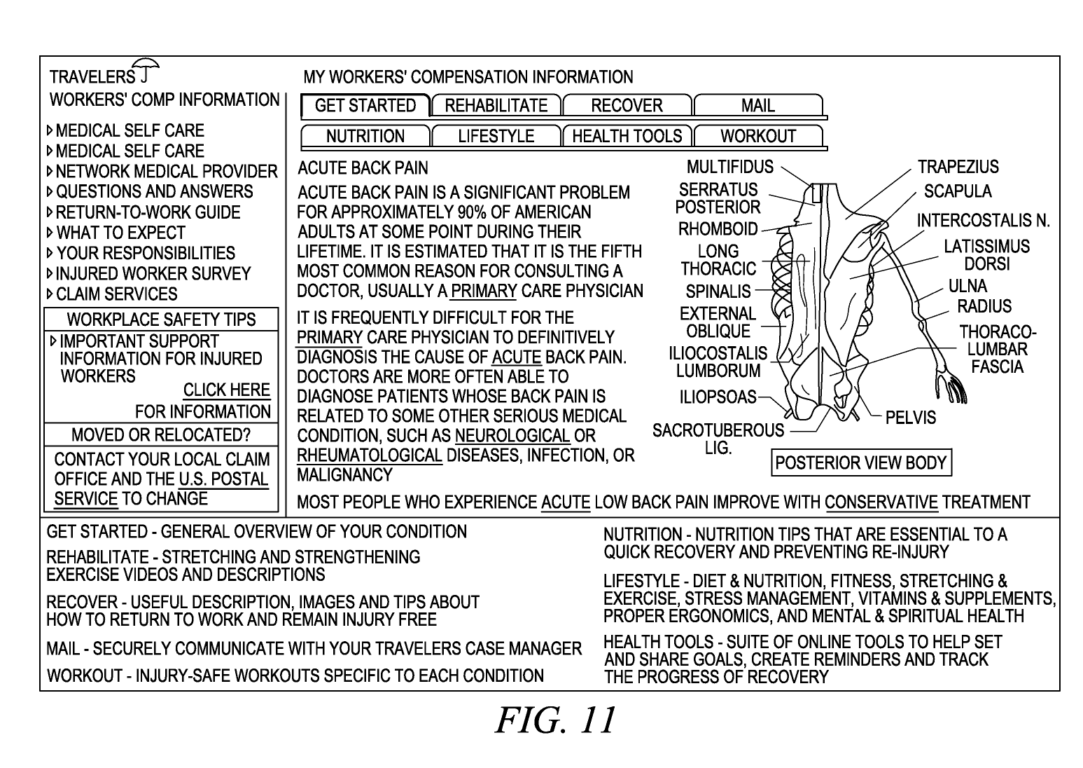

FIG. 11 is an example of a self-help component of a web portal. This component is part of a larger web portal that allows an injured employee to learn more about their condition (e.g., the insured bodily injury or disease) and manage multiple aspects of getting better and getting back to work. This includes reviewing an EOB, which can be reviewed in combination with information about their condition. FIG. 11 specifically shows that the web portal can contain medical self care tips for selected injury types.

The web portal helps injured employees help themselves and to use health data (claims, biometrics, etc.) to drive proactive, personalized health actions. The technologies (including the web portal) are designed to be easy-to-use and highly customizable. For example, there can be pre-developed programs for over 100 Workers Compensation type conditions. These include Acute Back Pain, Disc Injury, Ankle Sprain/Strain, Biceps Tendonitis, Carpal Tunnel Syndrome, Golfer's Elbow, Neck Sprain/Strain, and Repetitive Injuries to Hands. The web portal can be designed to easily develop programs for additional conditions and/or change content, as necessary.

Objectives of the web portal include offering information that will enable injured employees to better understand and become a partner in owning their condition and recovery. The injured employee can access self-help programs (multi-media presentations, educational materials, exercises, lifestyle tips, etc.) for their condition through the web portal. The injured employee can decide if the information is to be saved or not. Objectives also include helping injured employees change behavior to recover faster and stay healthy. The injured employee can use the Virtual Medical Self Management Tool to set goals, reward themselves, remind themselves of important actions and track their progress. The Virtual Medical Self Management Tool can also be driven by claims data and rules (e.g., claim X generates information Y and reminders Z1 and Z2). Objectives also include empowering the injured employee with his/her physician and encourage injured employees to print out evidence based medicine about their condition to discuss with their physicians. For example, discuss information about back injury and the risk/benefits of spine surgery with a spine surgeon.

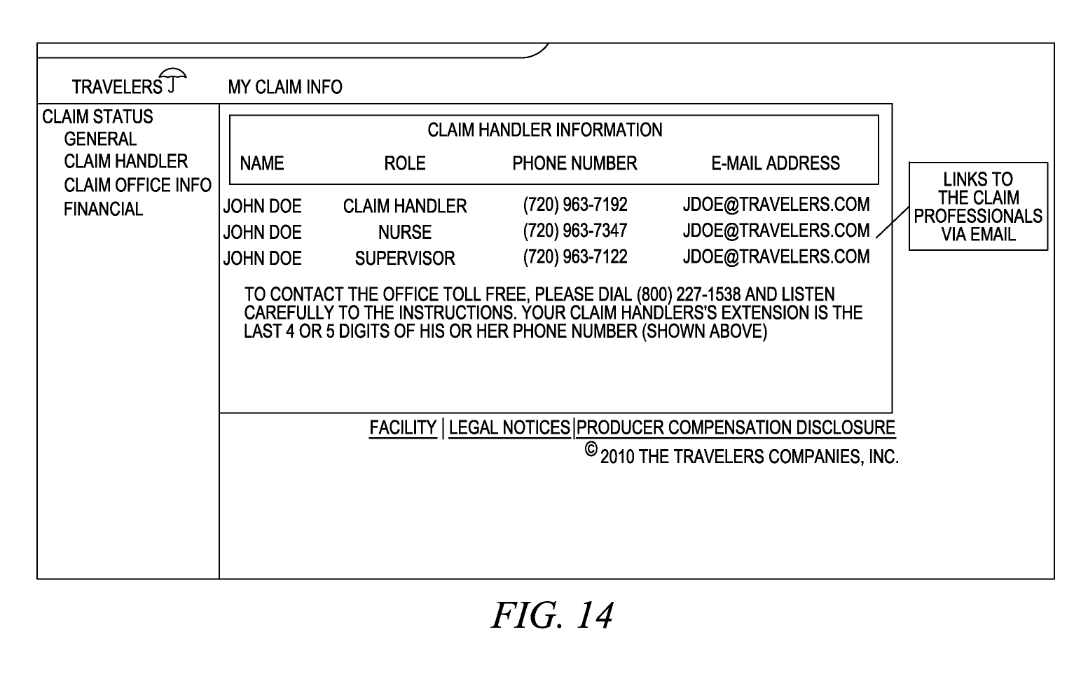

Other features of the web portal can include the ability to chat, for example with a medical professional such as a nurse, in real time about any injury related issues or concerns, e.g., by clicking on the “Get help with my claim” link/image (FIG. 9A) or by clicking on the name of the person/claim handler in My Claim Info screen (FIG. 14). If there is not a nurse available or assigned to a claim, “not available” can be displayed, along with a phone number of “unknown” and an email address of notavai@travelers.com. An icon can be included on the home page of the site to initiate a live chat session. The live chat would need to be manned by a pool of nurses and chat sessions can be distributed among the nurses based on availability and or relation to a case. If the nurses are not available 24/7, the live chat icon can specify the hours of availability. A chat could also be initiated with an insurance professional such as a claim case manager.

Other features of the web portal can include indemnity information, pharmacy information on drug and interactions, a score on overall health, and a health risk assessment. The indemnity information can let the injured employee review the status of their lost time or permanent partial disability payments. The pharmacy information can help the injured employee educate themselves and make sure that they do not take any combination of medications that may adversely affect them. The web portal can also provide a score on the overall injured employee's health; this can be based on their biographical information, claim data, treatment information, diagnostic lab results, and/or a health risk assessment. The health risk assessment can be performed on the web portal. The web portal can also provide health information and education, including video and links to more detailed information and images. The information provided can even be interactive with a computer program or with a health care provider, who can help the patient understand their condition.

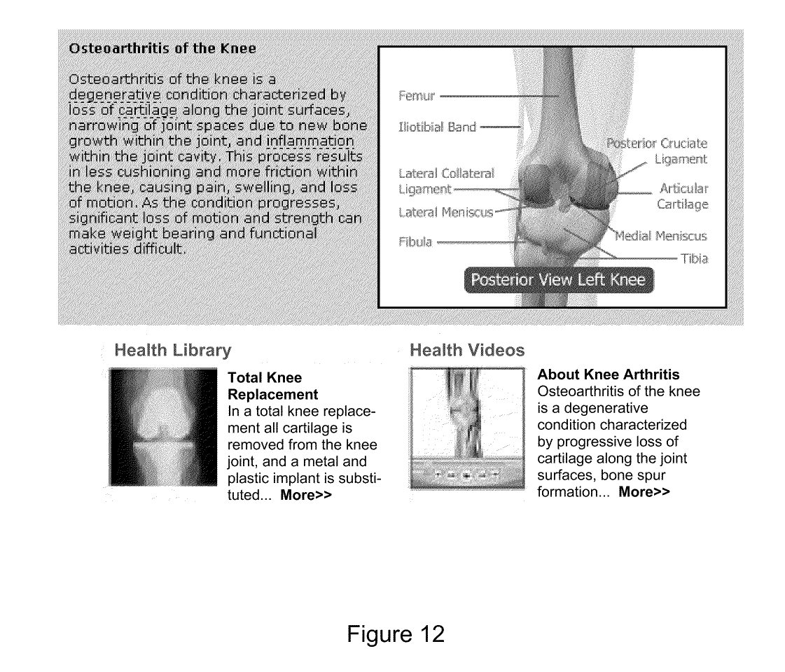

FIG. 12 is an example of a component of a web portal where a user can learn more about their specific injury as described above.

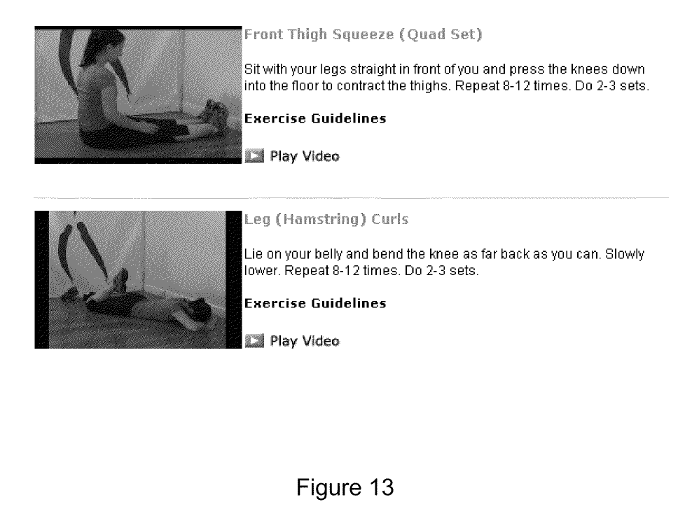

FIG. 13 is an example of a component of a web portal where a user can learn more about exercise and behavioral methods as described above.

FIG. 14 shows an example of a component of a web portal where a user can communicate with their claim and/or medical (e.g., physician or nurse) case manager. More specifically, the web portal supports the case manager—injured employee relationship. The case manager can be involved in the injured employee's self-help program. The web portal can be used by the case manager or injured employee to mail communications electronically, check accuracy of program components, add additional suggestions, and/or track compliance and progress.

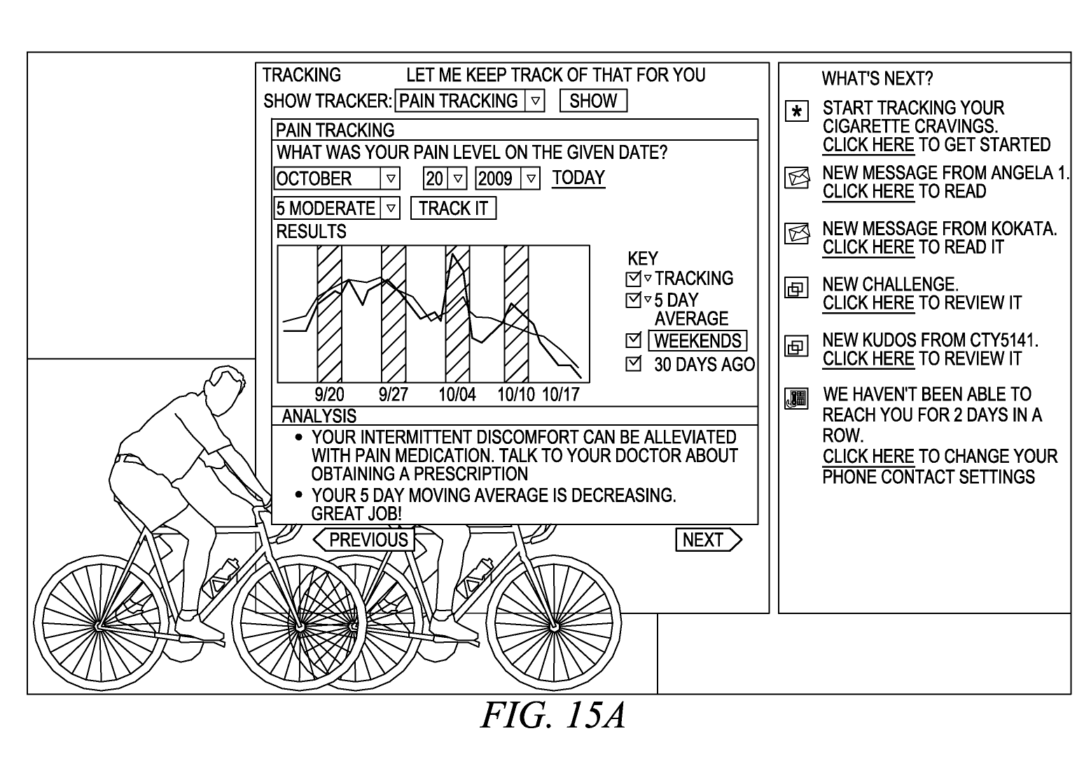

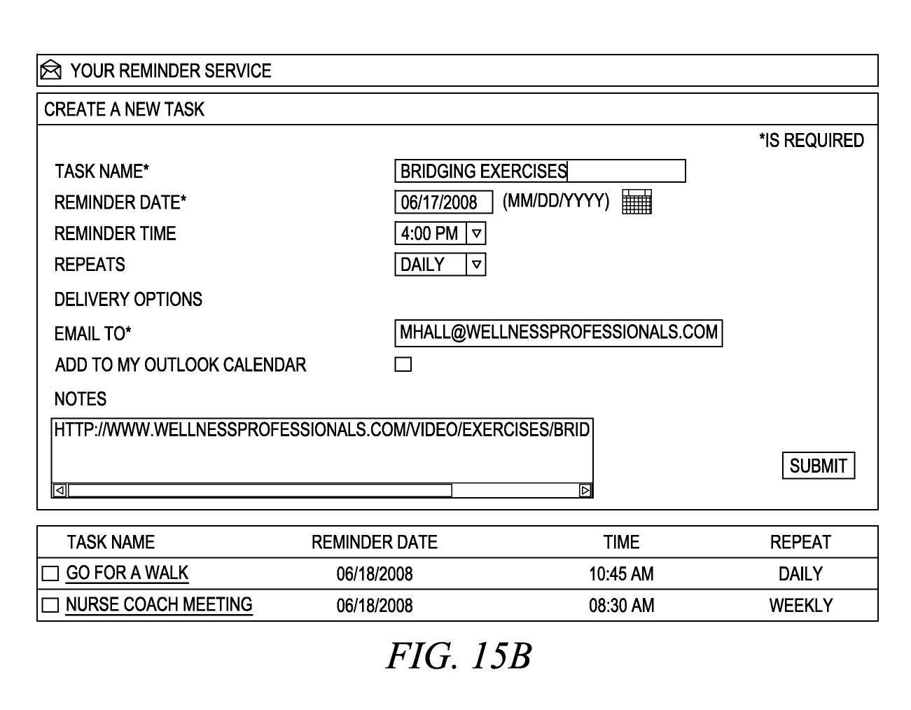

FIG. 15A is an example of a component of a web portal where a user can track their recovery progress. More specifically, the web portal also supports tracking, analyzing, and learning. Claim data and data provided by injured employees can be used to analyze the effectiveness of different interventions. FIG. 15B is an example of a component of a web portal where a user can create one or more recovery-related tasks.

Certain health support features, such as those shown and/or described herein with respect to FIGS. 12, 13, 15A, 16, and 17 may be provided by a third party vendor, such as Human Care Systems of Cambridge, Mass. (see www.humancaresystems.com for more detailed information regarding same), or any other vendor or company capable of providing the services or functions described herein.

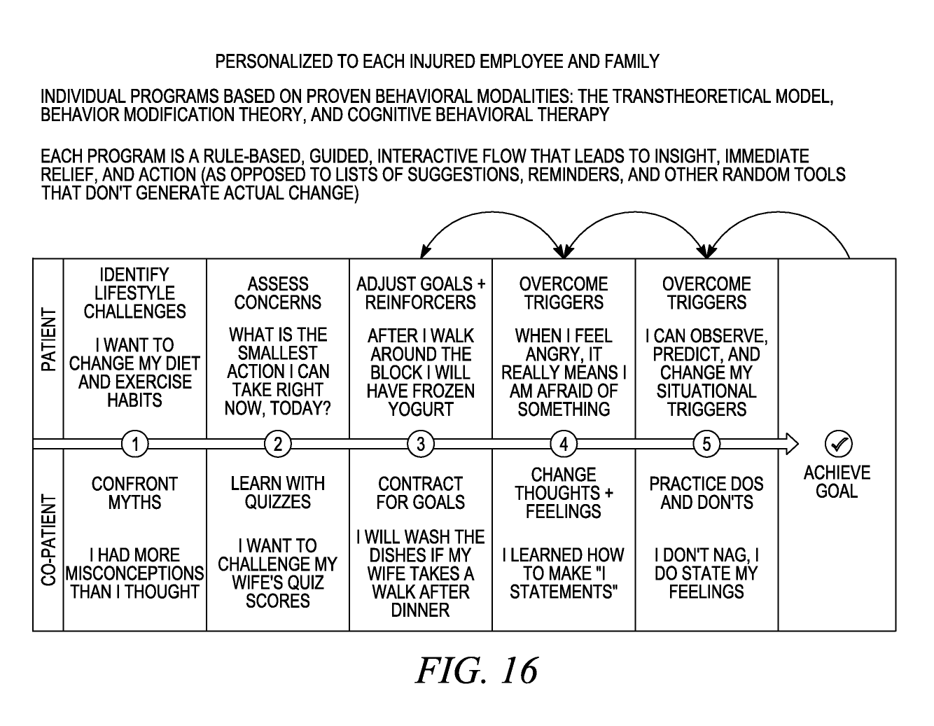

FIG. 16 is an example of a component of a web portal where a user can learn more about making behavior changes as described above.

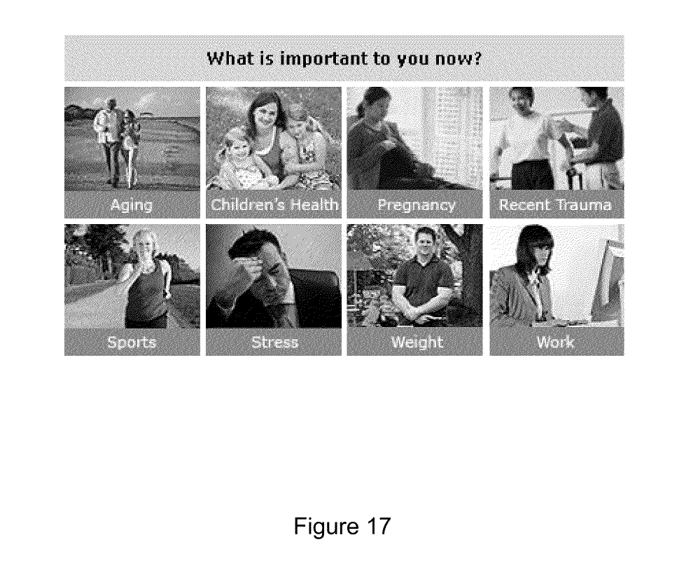

FIG. 17 is an example of a component of a web portal where a user can learn more about making lifestyle changes as described above.

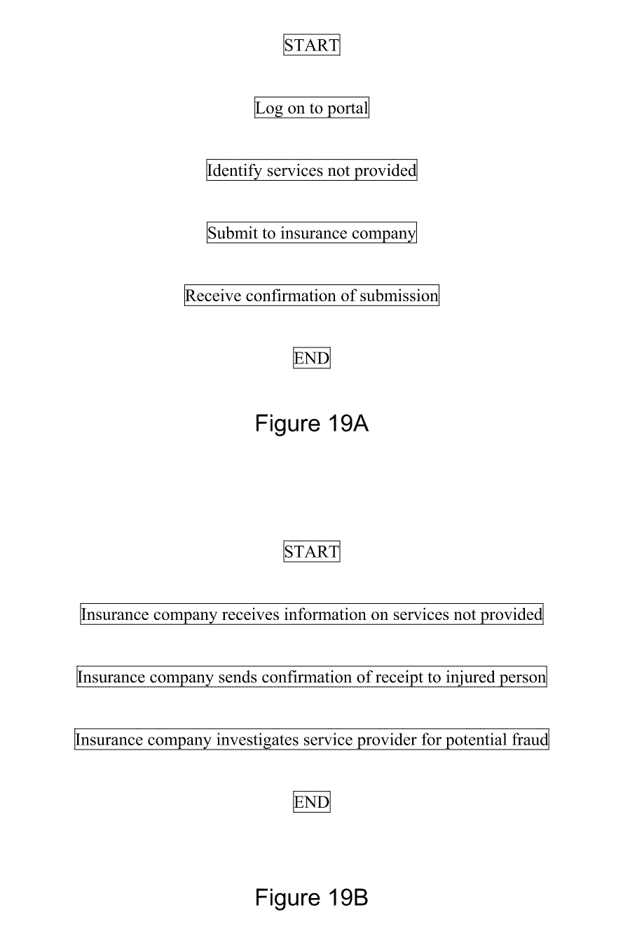

FIG. 18 is an example of a component of a web portal where a user can verify services provided as described above. In some embodiments, the user may check boxes or otherwise indicate services that were not provided. Such submissions may be provided confidentially to protect the identity or data of the injured employee/person. In other embodiments, the user may check boxes or otherwise indicate services that were provided. FIG. 19A is a flow diagram of at least one embodiment showing the process of verifying services provided. FIG. 19B is a flow diagram of at least one embodiment showing the process of investigating fraud.

The web portal can also allow an injured employee to check their claim status. There can be a link from within the web portal (or it can be part of the portal) where the injured employee can find details on their claim. The claim status components can have section headers to separate the content.

There can also be a link to Check My Claim Information Screens. This is the link from the site where an injured employee gets the detail on any check that was issued payable to them. The injured employee must establish secured access with a user name and password prior to being shown the financial detail. The Check My Claim Information section can display a ‘jump page’ You Will Be Redirected To A Secure Site, to assure the user that they are entering a secured site. It can also allow the user to opt to receive an email alert when a check is issued on the claim, which is payable to them. The injured employee can agree to some type of disclosure. There is an area where the injured employee can enter their email address (and verify) if they want to receive the alerts. The injured employee can also opt not to receive the alerts (i.e., turn them off).

When the SSN on a payment matches the injured employee's SSN, an email can be generated to the injured employee at the email address they entered. The alert will tell the injured employee that a payment was issued to them, and will have a link with it. If the receiver of the email clicks the link, they will be taken to the home page of the injured employee website, where they can enter their established user ID and password, before they are taken to the financial detail site, where they will see the newest payment, along with other payments that had been posted. The systems can address stop payments, payment updates, etc. so that the injured employee is only getting an alert when the payment issues the first time.

Sending an EOB to the employee provides (a) an opportunity to communicate with the injured employee that their employer has provided the benefit of full medical coverage without co-payment or deductible participation; (b) an opportunity to point out concerns in the pattern of medical care being received by the injured employee in cases where the insurer suspects medical treatment abuse; (c) an opportunity for the injured employee to authenticate that treatment was actually rendered in cases where medical treatment fraud is suspected by the employee or provider; and (d) it improves overall communication with the injured employee through a positive message to those who are progressing well and have returned to work.

Embodiments of the invention include sending an EOB to an injured employee, or any third party. In addition, a cover letter can be sent along to the injured employee as part of the EOB.

The EOB can be sent through one or more communication mediums in one or more formats depending on the injured employee's preferences and/or sophistication. For example, the EOB and cover letter can be communicated to the injured employee through email, fax, telephone, mobile telephone, postal mail, website, information terminal, and/or dedicated application. The EOB can also be sent in or more formats, which can be based on the communication medium. These formats can include plain text, HTML, XML, PDF, Excel, and graphically through images.

In some embodiments of the invention, the EOB can be sent by email, in which there may be check boxes next to at least one service provided (similar to FIG. 18) so that the injured employee can easily select or otherwise indicate those treatments that were not actually performed by the health care provider, or are different from what was actually performed, and send a reply email to the insurance company. This verification information may also be automatically populated on one or more verification screens for future reference. In some embodiments, the user may be required to verify that the services were indeed performed before the insurance company will authorize payments, thus providing further assistance in fraud detection. If the service providers know that the injured person must verify services provided, fraud may be deterred. In some embodiments, a link to the portal (www.mywcinfo.com) may be provided in the EOR (similar to that in the cover letter as shown at 314 in FIG. 3A) if desired.

In some embodiments of the invention, the cover letter can explain and address one or more of an injured employee's most common questions about the EOB. For example it can address (a) Q: What is this letter I have received? A: This is a copy of the Explanation of Reimbursement EOR that provides explanation to the health care provider of what is being paid in response to the bill they submitted; (b) Q: Do I have to pay anything? A: No, this is not a bill. This is just providing information to you of the treatment you have received and payments for those treatments made for you; (c) Q: How do I know what treatment I received? A: The Explanation of Reimbursement provides a brief description of the treatment you received, the date of that treatment and the related costs. Adapt the Procedure Codes link in CLAIMnet under the Reference Tab to publically provide the more detailed descriptions for the inquiries to the injured employee; and (d) Q: Why are you being billed for treatment that I haven't received? A: One reason we are sending you this EOB is to find out whether or not you received the treatment that we are being billed for. We sincerely thank you for pointing out this error in billing and we will follow up with the medical provider.

In some embodiments of the invention, the EOB package sent to the injured employee/person may be stored on the claim platform for later searching, retrieval, review, and printing. The copy sent to the injured employee and their attorney can both be stored. The dates of mailing and receiving of any responses can also be stored on the platform and linked with the stored documents. These documents can be stored using the tracking number. Similarly, the EOR sent to the health care provider can also be stored.

Another feature of the invention is the ability to reproduce the EOR or EOB on demand. These are legal documents that are often subpoenaed or used as evidence during litigation, and medical providers often request copies. In addition, state auditors can request copies.

The stored EOR and/or EOB can be linked to the health care provider's bill, stored either on the same or a different system. This way each document can be easily reviewed along with the bills. For example, selecting an entry on the EOR/EOB can retrieve the entire related bill. The linking can be done using a bill control number on the medical bill with the tracking number for the EOB package and EOR sent to the health care provider.

In some embodiments of the invention, if the injured employee has any other questions, the EOB will direct the injured employee to contact their respective claim handler with any questions or concerns with the bill or their overall medical care. The claim handler will report any suspected fraud to the Medical Fraud Hotline.

The EOB is sent in accordance with state and federal laws. Therefore, the EOB, and any other communication with the injured employee, is also sent to the injured employee's attorney, if they are represented by one.

In some embodiments of the invention, the EOB can be sent to all injured employees. In other embodiments of the invention, an EOB can be sent only to certain employees. For example, an EOB can be sent to one or more groups of employees, including employees not represented by attorney, employees receiving health care benefits over a certain threshold, employees with certain types of injuries, employees of certain employers, employees treated by health care providers being monitored or investigated, injured employees who lost time from work (as opposed to those employees who never lost time and who simply received some limited medical treatment), or for claims that are accepted as compensable. By sending an EOB to a more limited number of injured employees, the time and cost of sending EOBs can be reduced. Accordingly, an insurer is more likely to see a return on investment.

The EOB can also be sent when the insurer pays a bill, on a specific date, at a certain time (e.g., weekly or monthly), when medical payment to the health care provider is completed, or in a monthly summary batch process. EOBs can also be sent in batches or individually, depending on when they are generated. For example, in a batch generation system, all the EOBs generated the day before are sent the next day.

The EOB can be used to help identify fraud by a health care provider or pharmacy. The EOB is a subtle way to authenticate that the treatment actually was rendered or the medicines were actually dispensed as the patient has the opportunity to raise a concern if he/she sees a treatment and/or date of service that they never participated in.

Fraud can be tracked by including tracking information in the EOR and/or EOB. This tracking number can be any alphanumeric or other code, and can be used as a way to manage and identify the particular case within a case tracking system. A benefit of fraud capture would involve tracking the formation of major case medical provider fraud investigations. This methodology would involve tracking situations where the initial EOB single medical provider investigation led to the disclosure of systematic fraud relative to a significant dollar exposure and multiple claim files. Case dispositions, savings and recoveries likewise can be tracked. These cases could potentially lead to criminal prosecution and affirmative civil litigation against the suspect medical providers. Another benefit of fraud capture is deterrence and development of an insurer industry reputation relative to medical provider fraud.

In some embodiments of the invention, a referral can be made to a Medical Investigation Unit (MIU). A referral to a medical fraud investigator can be made any time there is a discrepancy between service rendered and received, or services that were never rendered. Referrals can be performed through an online case management system that manages cases using tracking information. For example, the user of the system can select a reason for the referral. Alternatively, the user can select “other” as the type of case, and enter in “BOB referral” or a more specific type.

It is to be understood that the embodiment(s) described above are not limited in its application to the details of construction and to the arrangements of the components set forth in the above description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

For example, the specific sequence of the above described process may be altered so that certain processes are conducted in parallel or independent, with other processes, to the extent that the processes are not dependent upon each other. Thus, the specific order of steps described herein is not to be considered as implying a specific sequence of steps to perform the above described process. Other alterations or modifications of the above processes are also contemplated. For example, further insubstantial approximations of the above equations, processes and/or algorithms are also considered within the scope of the processes described herein.

What is claimed is:

1. A computer-implemented method for providing medical self management information from a property/casualty insurer to an injured person who sustained an insured bodily injury, comprising providing at least one web portal to the injured person, wherein the providing comprises at least one of:
providing the at least one web portal to the injured person to view claim information, wherein the claim information comprises at least one of a listing of at least one medical procedure provided by a health care provider and a listing of payment information for at least one payment to the injured person, and wherein the claim information is responsive to at least one of a claim number, a document control number, a provider taxpayer number, a bill control number, a claimant name, a service date, and a link that is received electronically from the injured person
providing the at least one web portal to the injured person to access medical self-help programs, wherein the medical self-help programs comprise at least one of multi-media presentations, educational materials, and health tools; and
providing the at least one web portal to the injured person to communicate directly with at least one of an insurance professional and a medical professional.

2. The method of claim 1, wherein the injured person is at least one of a first party claimant and a third party claimant with regard to the insurer.

3. The method of claim 1, wherein the injured person is an injured employee of an insured employer, and wherein the employer holds workers compensation insurance with the insurer.

4. The method of claim 1, wherein the at least one payment is at least one of a reimbursement payment and a disability payment.

5. The method of claim 1, wherein the claim information is at least one of an explanation of reimbursement (EOR) and an explanation of benefits (EOB).

6. The method of claim 1, wherein the providing the at least one web portal to the injured person to view the claim information further comprises:
providing more than one view option for viewing the claim information.

7. The method of claim 1, wherein the providing the at least one web portal to the injured person to view the claim information further comprises:
providing an interactive option for viewing the claim information, wherein at least one medical procedure listed can be selected electronically by the injured person if it was not performed or if it differs from a procedure that was actually performed.

8. The method of claim 7, further comprising:
receiving electronically by the insurer from the injured person the at least one selected medical procedure that was not performed or that differs from a procedure that was actually performed.

9. The method of claim 1, wherein the multi-media presentations are health videos for the injured person to learn more about their condition.

10. The method of claim 1, wherein the multi-media presentations are exercise videos for the injured person to learn at least one of stretching and strengthening exercises to help rehabilitate and injury-safe workouts specific to a condition of the injured person.

11. The method of claim 1, wherein the multi-media presentations are interactive with a computer program.

12. The method of claim 1, wherein the multi-media presentations are interactive with a medical professional.

13. The method of claim 1, wherein the educational materials include an overview of a condition of the injured person.

14. The method of claim 1, wherein the educational materials include at least one of descriptions, images, and tips for the injured person about how to return to work and remain injury-free.

15. The method of claim 1, wherein the educational materials include at least one of nutrition tips and lifestyle tips.

16. The method of claim 1, wherein the health tools include tools for the injured person to perform at least one of setting goals, sharing goals, establishing rewards, creating reminders, and tracking recovery progress.

17. The method of claim 1, wherein the communication is at least one of an email and a live chat.

18. The method of claim 3, further comprising:
determining an identity of the insured employer responsive to the at least one of a claim number, a document control number, a provider taxpayer number, a bill control number, a claimant name, a service date, and a link that is received electronically from the injured employee; and
providing the at least one web portal to the injured employee responsive to the identity of the insured employer.

19. The method of claim 1, wherein the injured person is a member of at least one of a plurality of organizations insured by the insurer, and wherein the method further comprises:
electronically receiving a request from the injured person including member specific claim information;
determining, responsive to the member specific claim information, the at least one of a plurality of organizations associated with the injured person;
providing access, responsive to the member specific claim information, to a first portal for the injured person to view the member specific information, wherein the member specific information comprises at least one of a listing of at least one medical procedure provided by a health care provider and a listing of payment information for at least one payment to the injured person, and wherein the member specific information is responsive to at least one of a claim number, a document control number, a provider taxpayer number, a bill control number, a claimant name, a service date, and a link that is received electronically from the injured person;
providing access, responsive to the member specific claim information, to a second portal for the injured person to access medical self-help programs, wherein the medical self-help programs include multi-media presentations, educational materials, and health tools; and
providing access, responsive to the member specific claim information, to a third portal for the injured person to communicate directly with at least one of an insurance professional and a medical professional.

20. The method of claim 19, wherein at least one of the first web portal, the second web portal, and the third web portal are specific to the one of the plurality of organizations associated with the injured person.

21. A computer system for providing medical self management information from a property/casualty insurer to a injured person who sustained an insured bodily injury, using at least one web portal, wherein the at least one web portal comprises at least one of:
a claim information module providing the at least one web portal to the injured person to view claim information, wherein the claim information comprises at least one of a listing of at least one medical procedure provided by a health care provider and a listing of payment information for at least one payment to the injured person, and wherein the claim information is responsive to at least one of a claim number, a document control number, a provider taxpayer number, a bill control number, a claimant name, a service date, and a link that is received electronically from the injured person;
a medical self management module providing the at least one web portal to the injured person to access medical self-help programs, wherein the medical self-help programs comprise at least one of multi-media presentations, educational materials, and health tools; and
a communication module providing the at least one web portal to the injured person to communicate directly with at least one of an insurance professional and a medical professional.

22. A computer-implemented method for providing medical self management information from a property/casualty insurer to a injured person who sustained an insured bodily injury, comprising providing at least one web portal to the injured person, wherein the providing comprises:
providing the at least one web portal to the injured person to view claim information, wherein the claim information lists at least one medical procedure provided by a health care provider, wherein the claim information is responsive to at least one of a claim number, a document control number, a provider taxpayer number, a bill control number, a claimant name, a service date, and a link that is received electronically from the injured person, and wherein the at least one medical procedure listed can be selected electronically by the injured person if it was not performed or if it differs from a procedure that was actually performed.

23. The method of claim 22, further comprising at least one of:
providing the at least one web portal to the injured person to access medical self-help programs, wherein the medical self-help programs comprise at least one of multi-media presentations, educational materials, and health tools; and
providing the at least one web portal to the injured person to communicate directly with at least one of an insurance professional and a medical professional.
